(19) United States
(12) Patent Application Publication
(10) Pub. No.: US 2011/0180342 A1
(43) Pub. Date: Jul. 28, 2011

(54) MOTOR SUITCASE

(76) Inventor: Boris Kunc, Ljubligana (SI)

(21) Appl. No.: 13/122,410

(22) PCT Filed: Oct. 14, 2009
(86) PCT No.: PCT/SI2009/000049

§ 371 Date: Apr. 2, 2011

(30) Foreign Application Priority Data
Oct. 16, 2008 (SI) P-200800242

(51) Int. Cl. A45C 9/00; B62K 11/00; B60L 11/00

(52) U.S. Cl. 180/218; 180/21

(57) ABSTRACT

The motor suitcase is a combination of a motorcycle and luggage suitcase. It is composed of a suitcase that is adequately dimensioned and ergonomically designed to safely carry the stored content as well as the driver. Adequate wheels with break mechanism are installed on the bottom side and a steering mechanism with commands to control the engine and breaks, connected to the front wheel, is installed on the upper side. It is driven by an electric engine or an internal combustion engine.

The object of the invention is a luggage suitcase which is in the same time also a motorcycle for personal transport. It is equipped with wheels and steering mechanism, powered by an electric or internal combustion engine. Smaller versions can be carried as a suitcase or a back-pack and can be brought on board of means of public transport as personal luggage. The invention is therefore a combination of motorcycle and suitcase and can be classified in the field of motor vehicles—especially motorcycles.

Through a completely new approach, the invention successfully solves the technical problem of a better mobility of persons and their luggage, be it on trips where it essentially diminishes dependence on means of public transport, be it in cities where large storage volume permits the transport of goods from shopping centres etc. Consequently, it diminishes traffic load and environmental impact. The most important advantage of the solution is however the fact that—as with an ordinary suitcase—it is possible to enter in public and private premises with smaller versions of such a motor suitcase, to store them in such premises—e.g. hotel rooms, to transport them in lifts and to bring them along at personal luggage fare on all means of public transport as for instance a ferry, a train, a bus, an airplane. It is possible to carry them as a suitcase or a back-pack, e.g. on the stairs. At the same time, it is possible to seat on them and drive safely with all the luggage, stored inside them, on roads and—depending on the size and power—also on cycle lines and in pedestrian zones.

There are no known solutions in this field. The closest comparable solutions are in the field of portable and motorised suitcases:

U.S. Pat. No. 4,913,252—motorised suitcase powered by electricity with an extendable platform on which the driver stands up; equipped with several small rotating wheels. But it is designed for easier manipulation of cargo and does not have properties of a motorcycle.

U.S. Pat. No. 5,316,096—portable motorised suitcase in which the electricity power serves only as help to trail the suitcase and is not designed to carry a person.

There are also some solutions in the field of motor vehicles (U.S. Pat. No. 5,097,922, U.S. Pat. No. 4,094,374 and U.S. Pat. 3,934,669) yet these are foldable vehicles that resemble to suitcases in their form but do not have properties as the present invention.

The invention solves the problem with a suitcase of adequate shape, dimension and solidness that allows to safely carry the content, stored inside, and the person, seated on it. Adequate wheels with breaks are installed on the lower extremity and foldable or solid steering mechanism with commands to control the engine and breaks, connected to front wheel forks, is installed on the upper extremity. It can be powered by an electric motor with accumulator or by an internal combustion engine with fuel tank. The steering mechanism is connected to the front wheel in such a way that the steering axle is located adjacent to the front sidewall of the suitcase to allow the most profitable use of storage space. To enable inclination of front forks, the steering axle can be composed of at least two parts with a junction that allows an inclination of the steering axle different from the inclination of the front wheel forks. Normally, the motor suitcase is opened and closed by opening of one sidewall while the opposite sidewall is placed down. The opposite sidewall is optionally equipped with handle or belts for carrying it as a back-pack while the back vertical corner can be equipped with wheels for trailing. To facilitate carrying, it is important—especially in smaller versions—that the over-all weight is as low as possible. There is no need for high speed in smaller versions powered by internal combustion engine, therefore a weak 22.5 ccm gasoline engine with approx. 0.8 Kw can be used. Such engine is designed for chain saws and garden machines and allows operation in various positions without licking fuel. The latter is an especially important feature while using it in motor suitcase because it allows placing the motor suitcase down and transporting it with public transport. The motor suitcase equipped with such an engine would reach a speed between 20 and 30 km/h on plain while the weight of an empty motor suitcase would hardly exceed 10 kg. The electric version of a motor suitcase might reach a slightly lower speed due to the need to have low accumulator weight, yet it suits better airplane transport requirements. Relatively limited autonomy can be increased by using photovoltaic solar cells to load accumulator. The cells can be built-in as components of the motor suitcase. An automatic change-speed gear can be added for driving on slopes. Larger and more powerful versions of motor suitcases can be equipped with more powerful engines and more sophisticated change-speed gears to develop higher speeds.

1-9. (canceled)

10. Motor suitcase, which is a combination of a motorcycle and a suitcase and is by the shape, purpose and size similar to an ordinary suitcase where its interior is in principle empty to load the luggage and is suitable for normal carrying and transporting as a hand luggage with the public transport like trains, ferries, planes and buses
characterised by
that its housing is simultaneously a suitcase and the supporting frame and is realized as a self-supporting chassis in form of a regular traveling suitcase which completely maintains its original luggage carrying function and has no additional framework to support the vehicle.

11. Motor suitcase as claim 10
characterized by
that the two lateral surfaces of its self-supporting chassis which are designed to open the suitcase, can be made of woven fabrics as well as of thermoplastic or composite materials

12. Motor suitcase as claim 10
characterised by
that it has at the front and at the back of one of narrower (lower) sidewalls longitudinally installed wheels with break mechanism and on the opposite (upper) sidewall a steering mechanism with commands to control the engine and breaks, connected to the front wheel,

13. Motor suitcase as claim 10
characterised by
that it is driven by an electric engine or an internal combustion engine

14. Motor suitcase as claim 10
characterised by
that an armature which carries the wheels, the propelling engine and the steering mechanism with control commands, is built into the suitcase

15. Motor suitcase as claim 10
characterised by
that it is adequately dimensioned and ergonomically designed to meet requirements of driver's comfort.

16. Motor suitcase as claim 10
characterised by
that—to enable inclination of front forks—the steering axle comprises two parts with a junction that allows an inclination of the steering axle different from the inclination of the front wheel forks.

17. Motor suitcase as claim 10
characterised by
that it has on the lower extremity, above the wheels, concavities which serve as mudguards and on a proper point positioned foldable pedals to carry driver's feet.

18. Motor suitcase as claim 12
characterised by
that in the electric driven version the propelling engine might be installed as in-wheel electric motor on one or two wheels.
